(19) United States
(12) Patent Application Publication
(10) Pub. No.: US 2011/0298806 A1
(43) Pub. Date: Dec. 8, 2011

(54) SYSTEMS AND METHODS FOR GRAPHICALLY CONVEYING INFORMATION

(76) Inventor: G. Lynn Rasmussen, Salt Lake City, UT (US)

(21) Appl. No.: 13/161,490

(22) Filed: Jun. 15, 2011

Related U.S. Application Data
(63) Continuation-in-part of application No. 12/503,071, filed on Jul. 14, 2009.
(60) Provisional application No. 61/080,992, filed on Jul. 15, 2008.

(51) Int. Cl. G06T 11/20

(52) U.S. Cl. 345/440

(57) ABSTRACT

Systems and methods for providing graphical information regarding one or more patients' medical information are described. The graphical information can be used in various methods of graphical comparison, including graphical diagnoses, graphical comparison between patients, over time with a single patient, and/or over time with and/or between multiple patients. The graphical information can be used in place of and/or in conjunction with existing methods and systems for conveying medical information, including one or more textual methods and systems. The graphical information is provided electronically to any electronic or computer device or is provided in hard copy, such as a part of a patient's chart. The use of graphical patient medical information permits rapid and improved conveyance of information, and improves recognition and understanding of the most relevant medical information.

### RELATED APPLICATIONS

This application is a continuation-in-part of U.S. patent application Ser. No. 12/503,071, entitled “SYSTEMS AND METHODS FOR GRAPHICALLY CONVEYING PATIENT MEDICAL INFORMATION,” filed Jul. 14, 2009, which claims priority to U.S. Provisional Patent Application Ser. No. 61/080,992, entitled “SYSTEMS AND METHODS FOR GRAPHICALLY CONVEYING PATIENT MEDICAL INFORMATION,” filed Jul. 15, 2008; the disclosures of which are both incorporated herein in their entirety.

### BACKGROUND OF THE INVENTION

1. Field of the Invention

The present invention relates to systems and methods for graphically displaying and navigating through information, and more particularly to graphical methods and systems for rapidly conveying information, such as medical information.

2. Background and Related Art

Currently-available systems and methods for recording patient medical data and conveying the recorded data to others can be cumbersome and inefficient. Additionally, currently-available systems and methods may do a poor job of highlighting the most relevant or important information when the information is conveyed, increasing the risk of missing critical information that could be used to diagnose, treat, or otherwise assist a patient or doctor. The use of such systems and methods is time-consuming, causes unneeded delays, and may result in an unprofessional impression of medical professionals on patients.

For example, typical mechanisms and methods for conveying patient medical information involve words and descriptions provided in a somewhat-organized manner, requiring the medical professional to read through and evaluate a great deal of data. An amount of data needed to be perused may be essentially irrelevant to the medical professional's needs.

FIG. 1 illustrates some of the difficulties that may be encountered in perusing this type of information. FIG. 1 represents a list illustrating the informational content of a complete systems review. As FIG. 1 shows only the types of information that can be obtained during a complete systems review, it will be appreciated that a listing of information can become even more voluminous than the listing of information shown in FIG. 1. Therefore, it will be appreciated that physicians, nurses, administrators, and other medical professionals, as well as patients and other laypersons can find difficulty in reviewing, digesting, and understanding the information presented in a conventional fashion, and especially in discerning the most important information contained in write-ups using conventional methods and systems.

Thus, while techniques currently exist that are used for recording patient medical data and conveying the recorded data to others, challenges still exist, including that current techniques are cumbersome and inefficient. Accordingly, it would be an improvement in the art to augment or even replace current techniques with other techniques.

### SUMMARY OF THE INVENTION

The present invention relates to systems and methods for graphically displaying and navigating through information, and more particularly to graphical methods and systems for rapidly conveying information, such as medical information.

Implementations of the present invention provide graphical information regarding one or more patients' medical information, and may be used in various methods of graphical comparison, including graphical comparison between patients, over time with a single patient, and/or over time with and/or between multiple patients. Implementations of the present invention may be used in place of and/or in conjunction with existing methods and systems for conveying medical information, including one or more textual methods and systems. The graphical information may be provided electronically to any electronic or computer device or may be provided in hard copy, such as a part of a patient's chart. The use of graphical patient medical information permits rapid and improved conveyance of information, and may improve recognition and understanding of the most relevant medical information, as will be understood below.

Implementations of the present invention utilize graphical methods and systems to rapidly convey medical information, such as to medical professionals and to laypersons, including to patients. While particular graphical methods and systems are described herein, the illustrated systems and methods are intended to be illustrative. It is anticipated that alternative graphical methods and systems may be utilized other than those specifically described herein, and such alternative implementations are embraced by the present invention and the full scope of the present invention should be determined by reference to the appended claims.

Implementations of the present invention utilize a graphical rating or scoring system in relation to multiple aspects of a patient's medical information, and may extend the analysis to all aspects of a patient's medical information. Each item of medical information may receive a rating, score, grade, mark, evaluation, or other count, such as from one to ten, one to five, one to fifty, zero to ten, A to F, green to red, etc., and the rating information may be stored. The received rating information may be received numerically or graphically, or may be determined based on one or more responses to queries as to the patient's medical information. The information may also be received electronically, such as utilizing a computer or electronic device, or may be transferred into an electronic format from a paper, dictation, or other format. The received rating information may then be displayed graphically, such as using one or more bar charts, pie charts, images depicting a patient or a portion thereof, medical progress forms, tree structures, utilizing color information, and/or by some other graphical format, where it can be quickly and rapidly communicated.

In at least some implementations, multiple individual pieces of information may be displayed graphically, and some individual pieces of information may be combined to provide one or more average scores, ratings, etc. The average of multiple scores, ratings, etc. may also be provided or displayed graphically, either as part of a graphical representation of the individual scores, ratings, etc., or individually, or in combination with multiple average scores, ratings, etc. representing averages of other information items. In some implementations, averages of several averages may be displayed, and any number of layers of averages may be provided.

In some such implementations, a user may elect to drill down (and back up, if desired) through layers of graphical representations of averages, to better understand certain average scores and their components.

In some implementations, the invention also relates to a system for graphically conveying information through a tree structure, a bar graph, a depiction of a patient, or in any other suitable manner. In such implementations, the system comprises at least one category of information, and multiple subcategories of information in each category. Additionally, a graphical subcategory score can be associated with each of the subcategories. Accordingly, a display mechanism can communicate, in a graphically succinct manner, a graphical category score for the category, wherein the graphical category score is selected from an average of the graphical subcategory scores, a highest graphical subcategory score, and a lowest graphical subcategory score.

The graphical information provides a way to view, communicate, understand, and/or utilize medical information that has heretofore been unavailable. By way of example, medical professionals and even laypersons are able to quickly view and grasp a patient's medical situation using implementations of the present invention in ways that were previously impossible. The information may be additionally utilized in ways previously unavailable to assist in diagnosis and treatment.

In addition to the aforementioned features, the described systems and methods can comprise a number of other features and characteristics. Indeed, in one example, the described systems comprise a search feature that allows a user to search medical information according to ratings, scores, or other search criteria. In another example, the described systems and methods include means for generating and collecting billing information in near real-time. In still another example, the described systems comprise a mechanism for caching various levels of the information that have been viewed by the user.

While the methods and processes of the present invention have proven to be particularly useful in the area of medical care, those skilled in the art can appreciate that the methods and processes can be used in a variety of different applications, including in the area of providing dietary decisions, fitness evaluation, weight loss counseling, exercise coaching, automotive repair, educational counseling, inventory/sales reporting, and other types of care, diagnosis, treatment, and/or analysis to an individual, group, or entity.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the present invention may be learned by the practice of the present invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 illustrates a PRIOR ART textual method for conveying patient medical information;

FIG. 2 shows a representative computer system that may be used in conjunction with embodiments of the present invention;

FIG. 3 shows a representative networked computer environment that may be used in conjunction with embodiments of the present invention;

FIGS. 4-13 illustrate representative graphical displays that are illustrative of features of embodiments of the present invention;

FIG. 14 shows a representative graphical display comprising a representative embodiment of tree structure;

FIG. 15 shows a flow chart representing processes that may be used in accordance with embodiments of the present invention;

FIG. 16 illustrates a representative embodiment of a line graph representing a comparison between potential status and actual status of a patient;

FIG. 17 shows a screenshot of a representative embodiment including a text box; and

FIG. 18 shows a screenshot of a representative embodiment including a search feature.

### DETAILED DESCRIPTION OF THE INVENTION

A description of embodiments of the present invention will now be given with reference to the Figures. It is expected that the present invention may take many other forms and shapes, hence the following disclosure is intended to be illustrative and not limiting, and the scope of the invention should be determined by reference to the appended claims.

Embodiments of the present invention provide graphical information regarding one or more patients' medical information, and may be used in various methods of graphical comparison, including graphical comparison between patients, over time with a single patient, and/or over time with and/or between multiple patients. Embodiments of the invention may be used in place of and/or in conjunction with existing methods and systems for conveying medical information, including one or more textual methods and systems. The graphical information may be provided electronically to any electronic or computer device or may be provided in hard copy, such as a part of a patient's chart. The use of graphical patient medical information permits rapid and improved conveyance of information, and may improve recognition and understanding of the most relevant medical information, as will be understood below.

Medical information, as used herein, should be interpreted broadly, and includes any information that may be medically relevant, including symptom information, general patient information, medical history information, family medical history information, genetic information, medicinal information, treatment information, dietary information, pharmaceutical information, or any other information that relates to an individual.

Embodiments of the invention utilize graphical methods and systems to rapidly convey medical information, such as to medical professionals and to laypersons, including to patients. While particular graphical methods and systems are described herein, the illustrated systems and methods are intended to be illustrative. It is anticipated that alternative graphical methods and systems may be utilized other than those specifically described herein, and such alternative embodiments are embraced by the invention and the full scope of the invention should be determined by reference to the appended claims.

In accordance with an embodiment of the present invention, each item of medical information receives a rating, score, grade, mark, evaluation, color code, or other count (sometimes referred to herein as rating information or a score), such as from one to ten, one to five, one to fifty, zero to ten, A to F, A to Z, green to red, white to black, etc., and the rating information is stored. The received rating information is received numerically, alphabetically, and/or graphically, or is determined based on one or more responses to queries as to the patient's medical information. The information can also be received electronically, such as utilizing a computer or electronic device, or can be transferred into an electronic format from a paper, dictation, or other format. The received rating information is then displayed graphically, such as using one or more bar charts, pie charts, images depicting a patient or a portion thereof, medical progress forms, tree structures, utilizing color information, and/or by some other graphical format, where it can be quickly and rapidly viewed and digested.

In at least some embodiments, multiple individual pieces of information are displayed graphically, and some individual pieces of information are combined to provide one or more average scores, ratings, etc. The average of multiple scores, ratings, etc. can also be provided or displayed graphically, either as part of a graphical representation of the individual scores, ratings, etc., or individually, or in combination with multiple average scores, ratings, etc. representing averages of other information items. In some embodiments, averages of several averages are displayed, and any number of layers of averages is provided. In some such embodiments, a user elects to drill down (and back up, if desired) through layers of graphical representations of averages, to better understand certain average scores, ratings, as well as to better understand high or low scores, and their components.

The graphical information provides a way to view, understand, and utilize medical information that has heretofore been unavailable. Medical professionals and even laypersons can quickly view and grasp a patient's medical situation using embodiments of the present invention in ways that were previously impossible. The information can be additionally utilized in ways previously unavailable to assist in diagnosis and treatment. While not all advantages and improvements in patient diagnosis, treatment, and care provided by the embodiments of the invention have been explicitly set forth herein, it is anticipated that such advantages and improvements will be understood from the description and Figures and by practicing the invention.

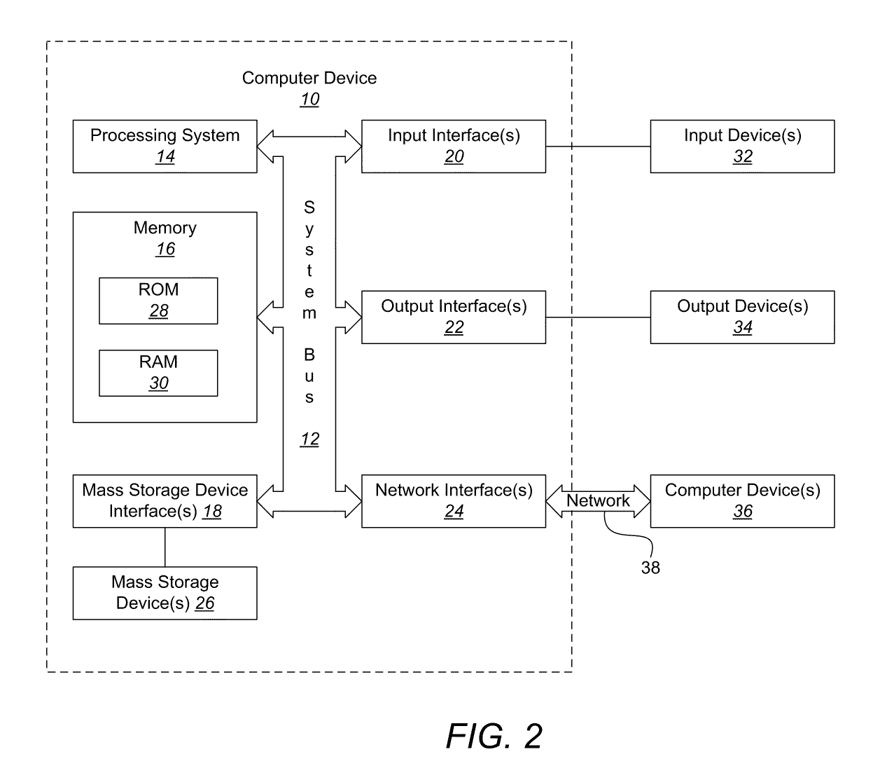

FIG. 2 and the corresponding discussion are intended to provide a general description of a suitable operating environment in which the invention may be implemented. One skilled in the art will appreciate that the invention may be practiced by one or more computing devices and in a variety of system configurations, including in a networked configuration.

Embodiments of the present invention embrace one or more computer readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

With reference to FIG. 2, a representative system for implementing the invention includes computer device 10, which may be a general-purpose or special-purpose computer. For example, computer device 10 may be a personal computer, a notebook computer, a personal digital assistant (“PDA”) or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, or from a communication connection, which may also be viewed as a computer readable medium.

Memory 16 includes one or more computer readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), a firewire (IEEE 1394), or another interface.

One or more output interfaces 22 may be employed to connect one or more corresponding output devices 34 to system bus 12. Examples of output devices include a monitor or display screen, a speaker, a printer, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

Those skilled in the art will appreciate that embodiments of the present invention embrace a variety of different system configurations. For example, in one embodiment the system configuration includes an output device (e.g., a multifunctional peripheral (“MFP”) or other printer/plotter, a copy machine, a facsimile machine, a monitor, etc.).

In another embodiment, the system configuration includes one or more client computer devices, optionally one or more server computer devices, and a connection or network communication that enables the exchange of communication to an output device, which is configured to perform multi-colorant rendering.

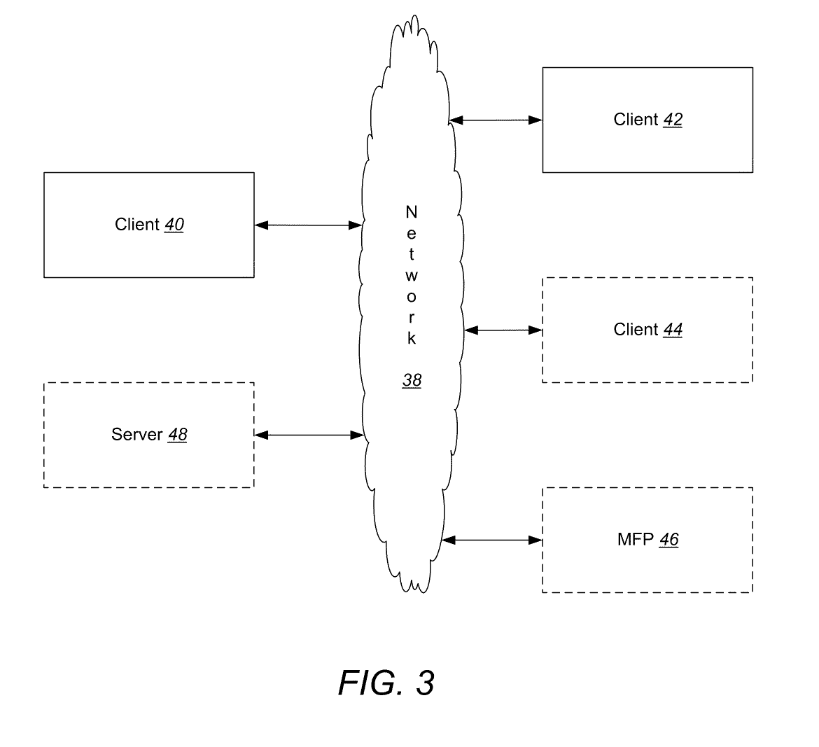

Those skilled in the art will further appreciate that the invention may be practiced in networked computing environments with many types of computer system configurations, FIG. 3 represents an embodiment of the present invention in a networked environment that includes clients connected to a server via a network.

In the representative embodiment illustrated in FIG. 3, one or more clients (40, 42, 44) can access patient information across a network 38, such as from server 48, for the rendering of the information in accordance with embodiments of the present invention on the one or more clients (40, 42, 44) and/or using a printing device, such as MFP 46.

While FIG. 3 illustrates an embodiment that includes a client 40, two additional clients (client 42 and client 44), one peripheral device (MFP 46), and optionally a server 48, which may include a print server, connected to network 38, alternative embodiments include more or fewer clients, more than one peripheral device, no peripheral devices, no server 48, and/or more than one server 48 connected to network 38.

Other embodiments of the present invention include local, networked, or peer-to-peer environments where one or more computer devices may be connected to one or more local or remote peripheral devices. Moreover, embodiments in accordance with the present invention also embrace a single electronic consumer device, wireless networked environments, local, and/or wide area networked environments. Embodiments in accordance with the present invention further include a multitude of clients throughout the world connected to a network, where the network is a wide area network, such as the Internet.

As embodiments of the invention provide graphical representation of medical information, any type of display device or technology may be used in conjunction with embodiments of the present invention, including televisions, monitors, projectors, general-purpose and custom handheld screens, etc. It will be appreciated that future computer and graphical display technology may also be utilized with embodiments of the present invention.

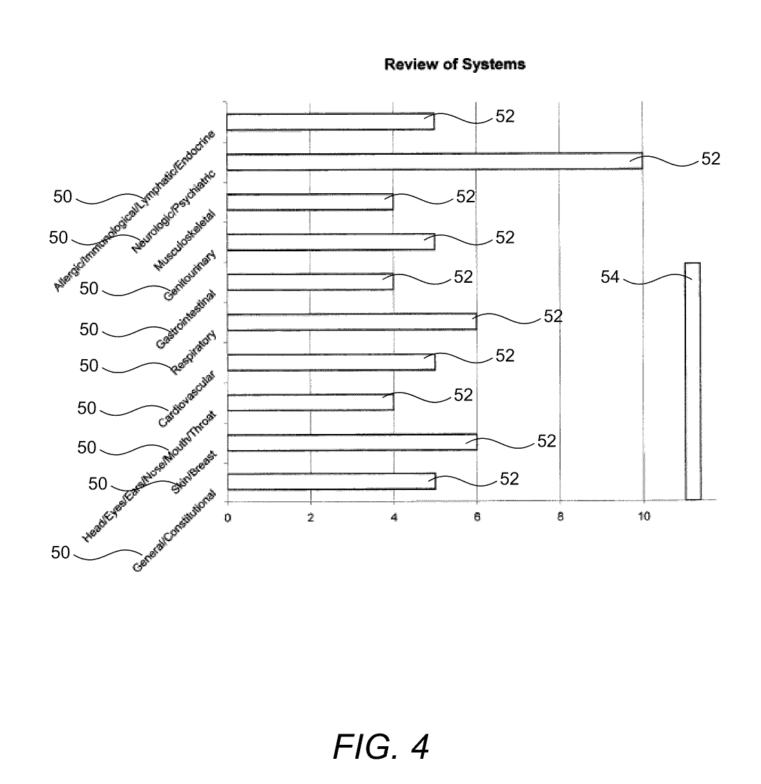

One embodiment of a graphical representation of patient medical information, as it may be generated by a computer, a dedicated electronic device, or by any other process (as will be appreciated below), is illustrated in FIG. 4. As has been discussed above and will be discussed below, the graphical representation of FIG. 4 is merely illustrative. The graphical representation of FIG. 4 provides a general review of systems, and may provide a user (such as a medical professional or a layperson) with a general overview of a patient's past or present medical status. In the illustration of FIG. 4, the graphical representation has been provided with a number of categories 50, each category 50 having a graphical score 52 associated therewith. The categories 50 may include any desired category selections, and may be varied to suit a particular purpose, such as a particular diagnostic design, a particular type of medical practice, etc. The categories 50 of FIG. 4 may be considered to be a general review of systems, and therefore include the following category selections: 1) Allergic/Immunological/Lymphatic/Endocrine, 2) Neurologic/Psychiatric, 3) Musculoskeletal, 4) Genitourinary, 5) Gastrointestinal, 6) Respiratory, 7) Cardiovascular, 8) Head/Eyes/Ears/Nose/Mouth/Throat, 9) Skin/Breast, and 10) General/Constitutional. While ten specific category selections are represented among categories 50, any number or type of selections may be included.

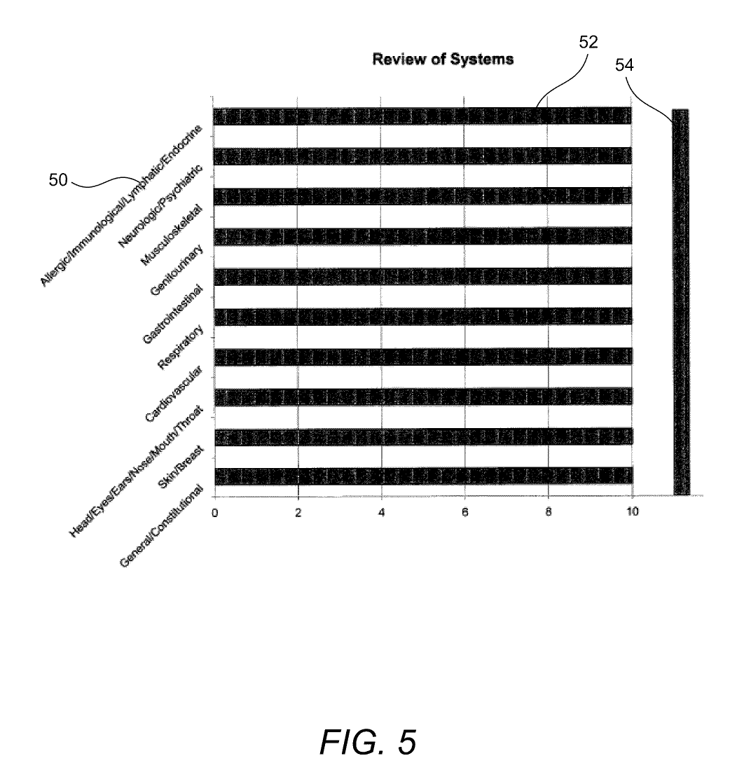

As set forth above, each category has a graphical score 52 associated therewith. In the graphical representation of FIG. 5, the graphical scores 52 may range from zero to ten. This number has been arbitrarily selected, and such scores may range on any desired scale, such as from zero to five, one to ten, one to five, zero to fifty, A to Z, A to F, etc. In addition, the graphical scores 52 need not necessarily have corresponding numerical values, per se, but may have other graphical signals, such as color, shape, or intensity, to represent the graphical scores 52. In the representation of FIG. 4, the numerical value of the graphical scores 52 may have wellness associated with either the maximum or the minimum score value (i.e., either ten or zero in the scale of FIG. 4). That is to say that in some embodiments, a high value of the graphical score 52 may represent wellness in the corresponding category 50, while in other embodiments, a low value of the graphical score 52 may represent wellness in the corresponding category 50. In some embodiments, the user may elect whether the high value or the low value represents maximum wellness, and in some embodiments, the representation may be switched at will.

Thus, in a system where a high value represents wellness, a display such as shown in FIG. 4 would indicate the highest degree of wellness in the system category 50 of “Neurologic/Psychiatric,” as that category 50 has a maximum rightward graphical extent/graphical score 52, corresponding to a numerical score of ten. In contrast, in a system where a low value represents wellness, a display such as shown in FIG. 4 would indicate the highest degree of wellness in the system categories 50 of “Musculoskeletal,” “Gastrointestinal,” and “Head/Eyes/Nose/Mouth/Throat,” as each of those categories 50 have the minimum rightward graphical extent/graphical score 52, corresponding to a numerical score of four.

As may be appreciated, a user viewing a graphical representation such as depicted in FIG. 4 will be very quickly able to determine areas of potential trouble for the associated patient. Indeed, as the user becomes familiar with the information displayed in the graphical representation, it will become less necessary for the user to refer to the category descriptions that may be displayed on the graphical representation, and such descriptions may even be omitted from some displays in at least some embodiments. Indeed, though the numerical values corresponding to the graphical scores 52 are shown along the bottom axis of the graphical representation of FIG. 4, in some embodiments those values may be omitted and the relevant information may be displayed exclusively through the rightward extent of the graphical scores 52.

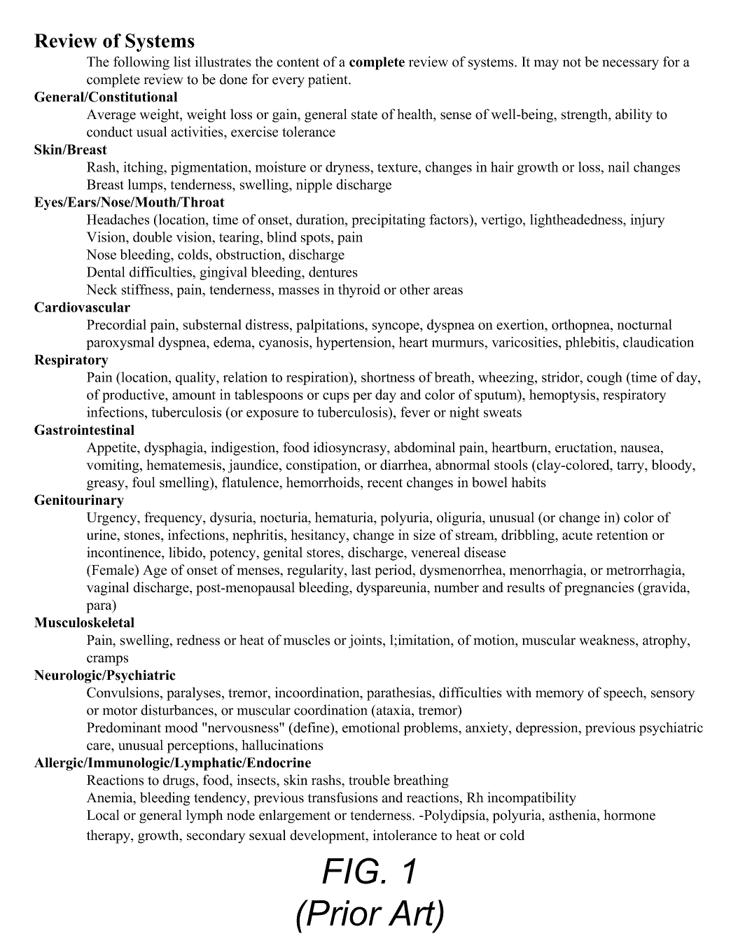

Even when the various categories 50 are labeled, a user of embodiments of the present invention need not fully utilize all the information contained in the various labels. For example, a general physician may review the graphical representation of FIG. 4 and may immediately determine that the most troubling item is the “Neurologic/Psychiatric” category (assuming a low score represents wellness), and may only read the label for that category on a first examination. Thus, instead of having to wade through a long written list of positive and negative symptom information (see the PRIOR ART information of FIG. 1), the physician can obtain what is likely the most relevant and important information at a glance. Other, less important information may also be rapidly conveyed, and may be further investigated as warranted.

In some embodiments, additional graphical information may be provided. For example, the graphical representation of FIG. 4 includes an average graphical score 54. The average graphical score 54 may represent an average of all the graphical scores 52 shown in the graphical representation, or may represent some other average or information. The average graphical score 54 may be represented in a different graphical orientation or format for contrast and/or clarity (as shown in FIG. 4), or it may be represented similarly to the other graphical scores 52 and set apart via textual information or some other identifier. The user may reference the average graphical score 54 to obtain more general information about a certain portion of (e.g., a system) or all the medical information represented, such as the patient's general health.

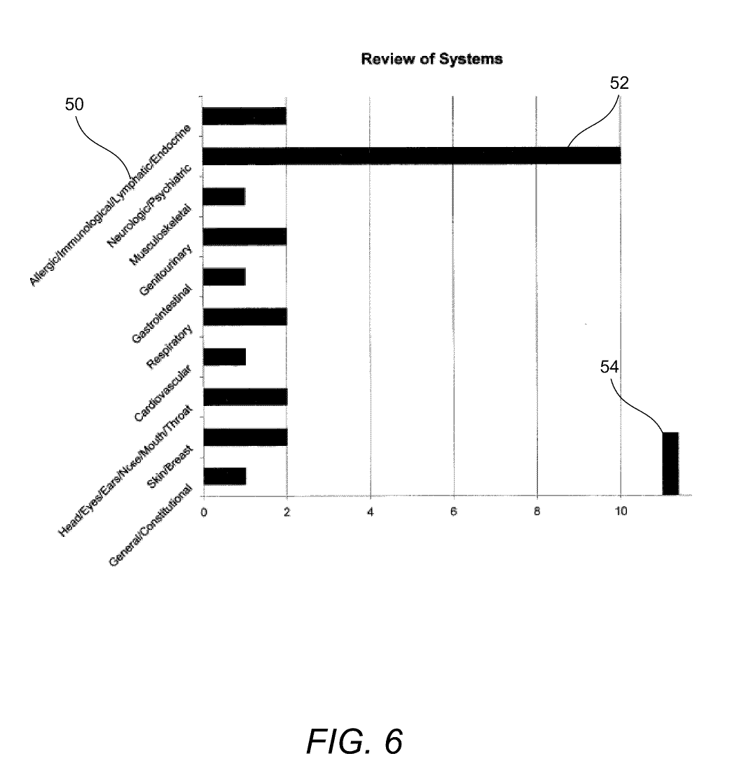

FIGS. 5 and 6 present graphical representations similar to that of FIG. 4. The graphical representation of FIG. 5 may correspond to a hypothetical perfectly-healthy individual, if a high graphical score 52 represents wellness. Alternatively, if a high graphical score represents sickness, the graphical representation of FIG. 5 might correspond to a patient suffering from hypochondria or to a very-ill patient. The graphical representation of FIG. 6 would likely be quickly interpreted as representing a generally-well person with one problematic area or a generally-sick person with one area of no concern, depending on whether high or low graphical scores 52 correspond to wellness. Regardless, it will be readily apparent from FIG. 6 that a user of the embodiments of the present invention will be able to nearly instantly determine problem and/or non-problem areas utilizing the graphical representations discussed herein in a way not currently available.

It should be appreciated that in some instances it may be desirable to provide more detailed information than can be graphically represented in a single graphical representation (such as those of FIGS. 4-6). In some embodiments, additional information may be presented textually or otherwise. Alternatively or additionally, in some embodiments, additional information may be presented graphically. For example, a user may decide that he or she wants more information about a specific category 50, such as “Musculoskeletal.” In some embodiments, a user may either turn to a page representing additional information related to the selected category 50 (if the graphical representations are in hard copy format), or may utilize an input device to select a particular category 50 or graphical score 52 for more information. In this way, the user can “drill down” to find more information.

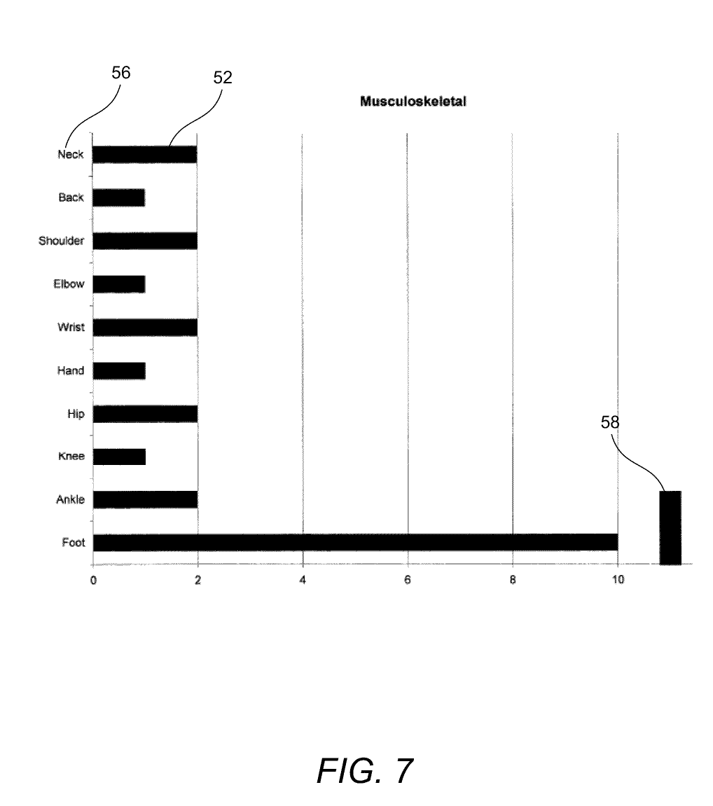

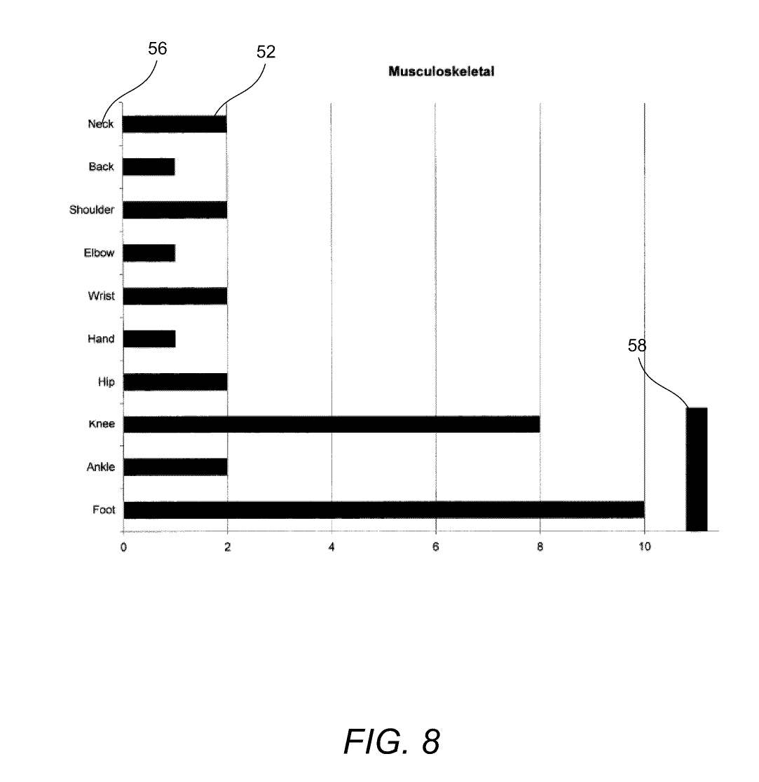

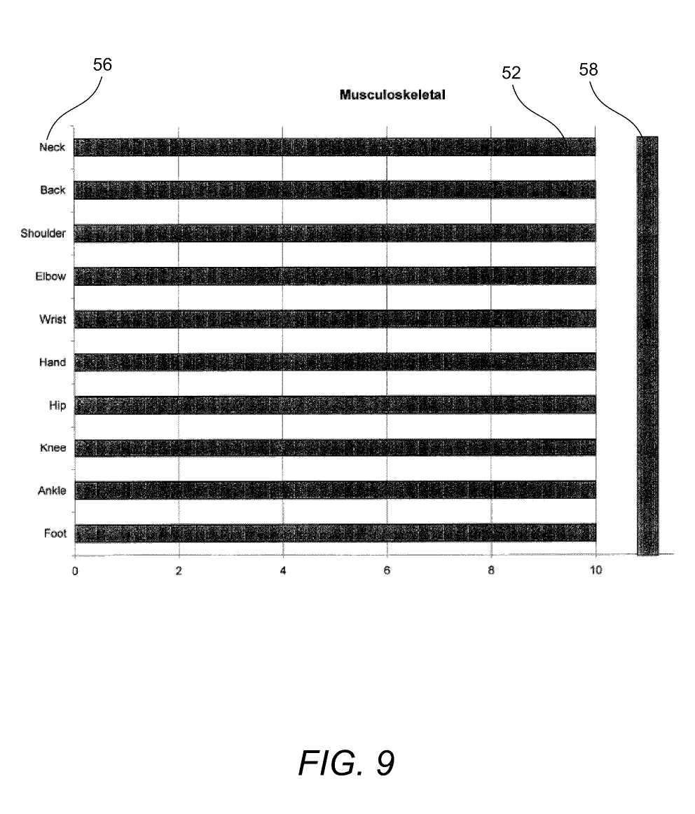

FIGS. 7-9 show representations of a graphical representation that might be displayed upon selection of the “Musculoskeletal” category 50. In these Figures, the categories 50 might be replaced by new subcategories 56. The subcategories 56 may represent the information utilized to provide the graphical score 52 associated with the general “Musculoskeletal” category 50 (as shown in FIGS. 4-6).

Additionally, while a general graphical score for a category (e.g., the “Musculoskeletal” category) can be given based on the lowest graphical score (e.g., back, elbow, hand, and knee) or the highest graphical score (e.g., foot) of its subcategories, in some embodiments, a subcategory average graphical score 58 may be provided. In such embodiments, the subcategory average graphical score 58 may be the same as the graphical score 52 shown in conjunction with the general “Musculoskeletal” category 50 (as shown in FIGS. 4-6). By way of example only, the subcategories 56 such as those shown in FIGS. 7-9 may include 1) Neck, 2) Back, 3) Shoulder, 4) Elbow, 5) Wrist, 6) Hand, 7) Hip, 8) Knee, 9) Ankle, 10) Foot. While ten specific subcategories 56 have been illustrated, any number or type of subcategories 56 may be utilized, such as to suit a particular diagnosis or treatment purpose.

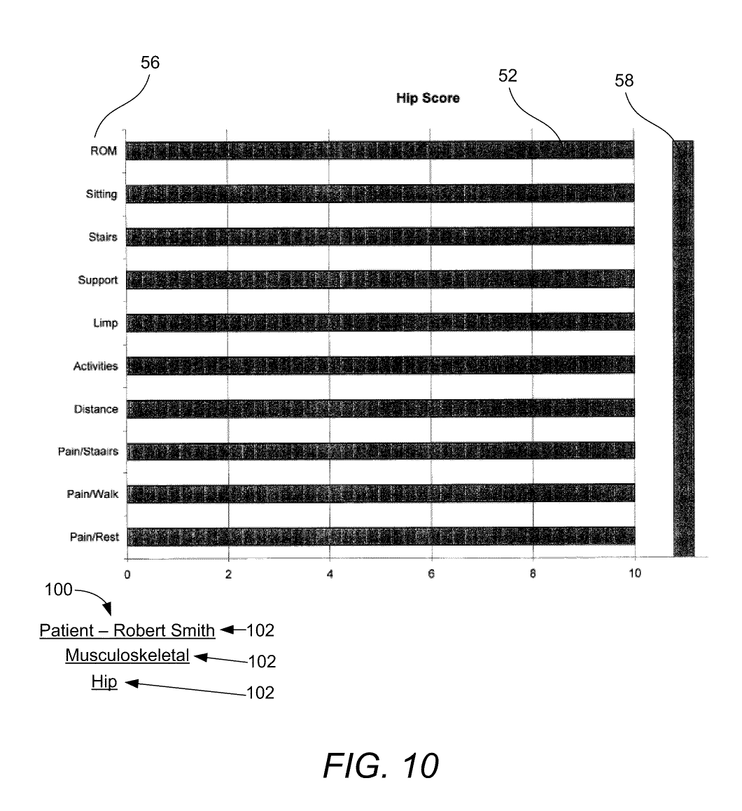

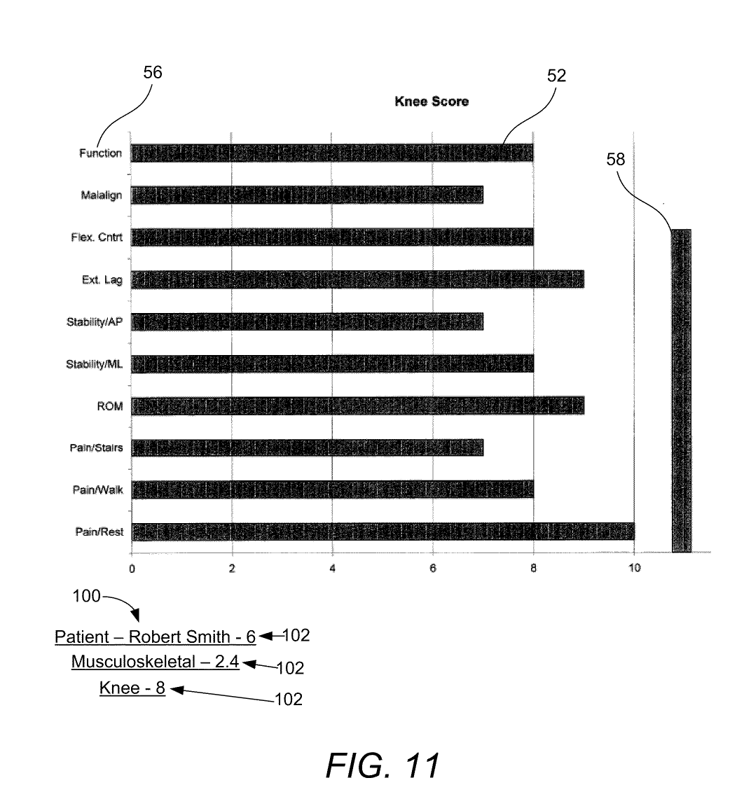

The subcategories 56 and the graphical scores 52 associated therewith may be utilized in similar fashion to the categories 56 and the graphical scores 52 associated therewith. In addition, further drilling down to more specific medical information (whether textually-displayed, graphically-displayed, or otherwise-displayed) may be possible. For example, if one of the “Hip” or “Knee” subcategories 56 or corresponding graphical scores 52 of FIGS. 7-9 is selected, a new graphical display, such as illustrated in FIG. 10 or 11, may be displayed.

In the graphical display of FIG. 10, new subcategories 56 (sometimes called sub-subcategories) are presented in relation to the previous subcategory of “Hip,” with their corresponding graphical scores 52 and the corresponding subcategory average graphical score 58. By way of example only, the new subcategories 56 presented may include 1) ROM, 2) Sitting, 3) Stairs, 4) Support, 5) Limp, 6) Activities, 7) Distance, 8) Pain/Stairs, 9) Pain/Walk, and 10) Pain/Rest. In the graphical representation of FIG. 11, new subcategories 56 are presented in relation to the previous subcategory of “Knee,” with their corresponding graphical scores 52 and the corresponding subcategory average graphical score 58. By way of example, the subcategories 56 may include 1) Function, 2) Malalign, 3) Flex. Cntrt., 4) Ext. Lag, 5) Stability/AP, 6) Stability ML, 7) ROM, 8) Pain/Stairs, 9) Pain/Walk, 10) Pain/Rest.

As may be appreciated, further drilling down may be possible, and it may also be possible to drill back up, such as by selecting the subcategory average graphical score 58, the graphical representation title, or a “Back” icon (not shown). Any known mechanism for navigation or moving between graphical displays and representations is embraced by the embodiments of the present invention.

In some embodiments, a bread crumb trail is provided as a user drills down and/or up through the various categories 50 and subcategories of a patient's medical information. In this manner, the user can easily find his or her place in the patient's information or can skip to a desired location in the patient's information by selecting a desired category or subcategory from the bread trail. While this history can take any suitable form, FIG. 10 shows some embodiments in which the bread trail 100 includes a link 102 to each category, subcategory, and/or sub-subcategory the user visits as the user navigates through the patient's medical information.

Where the described systems and methods include a bread crumb trail 100, the trail can be organized in any suitable manner. Indeed, in some embodiments, the bread crumb trail includes a listing of links to the various categories and subcategories of information the user has visited during a single session or over several sessions. In other embodiments, the bread crumb trail only indicates the subcategories and sub-subcategories a user has visited within a category.

Where the systems and methods include a bread crumb trail 100, the bread crumb trail can also comprise scores or rating information to allow the user to quickly find information of interest. By way of example, each link to a particular category or subcategory may include a numerical score, a color code, symbol, etc. that is associated with one or more average ratings/scores, highest ratings/scores, or lowest rating/scores that are associated with each category or subcategory. Indeed, FIG. 11 shows some embodiments in which each link 102 comprises a rating (e.g., 6, 2.4, 8) that indicates the average rating information for each category and subcategory listed in the bread crumb trail 100.

In some embodiments, it may be desirable to transition to specific textual comments relating to a particular category 50 and/or subcategory 56 and the associated graphical scores 52. In some embodiments, the transition may occur automatically upon drilling down to a most-detailed level of graphical representation. In alternate embodiments, the transition may occur at any graphical display upon selection by the user, such as by an alternative input at an input device or upon some other selection. In still other embodiments, a link to such textual information (not shown) may be provided with respect to any piece of information/category 50/subcategory 56/graphical score 52/etc.

In some embodiments, some textual information provided can be provided with detail corresponding to the level of detail in the associated graphical representation. In other embodiments, the textual information may have a single level of detail, and transitioning to the textual information may occur to a particular relevant point within the textual information or may include highlighting the relevant textual information in some way. In some embodiments, the graphical and textual information may be simultaneously presented, such as side-by-side or above-and-below, to best convey information in the manner desired by the user. Additionally, the “textual information” displayed may include graphical or other information of the type currently provided with patient medical information, where appropriate. In this way, the user may be provided with all information available previously, but supplemented with the rapidly-digested graphical information discussed herein.

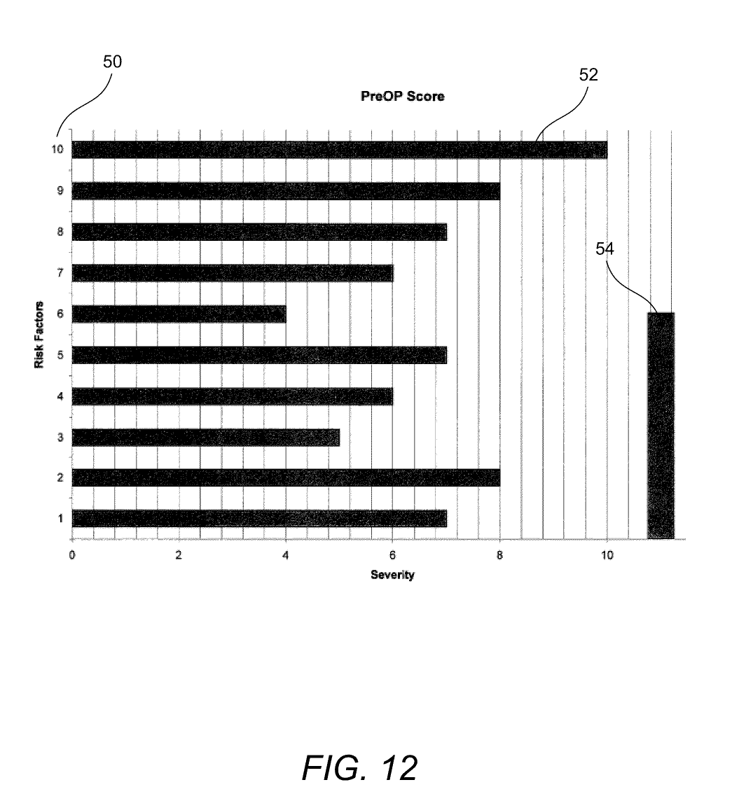

As discussed above, the graphical representations may be customized and/or focused for any specific needed application. For example, FIG. 12 illustrates a graphical representation that might be used to evaluate a patient prior to an operation or other surgical or non-surgical procedure. A medical professional may, at a glance, decide that proceeding under certain circumstances would be unwise and may recommend treatment to lower certain risk factors, etc. Additionally or alternatively, a pre-operation and a post-operation set of graphical representation(s) may be prepared and compared. In this way, an evaluation of the success of the procedure and/or how well the patient came through the procedure may easily be made. This may be done, for example, by preparing and comparing two graphical representations. Alternatively, the pre- and post-information may be prepared on a single graphical representation, and may be demarcated by order, color, shading, placement, identifiers, intensity, etc.

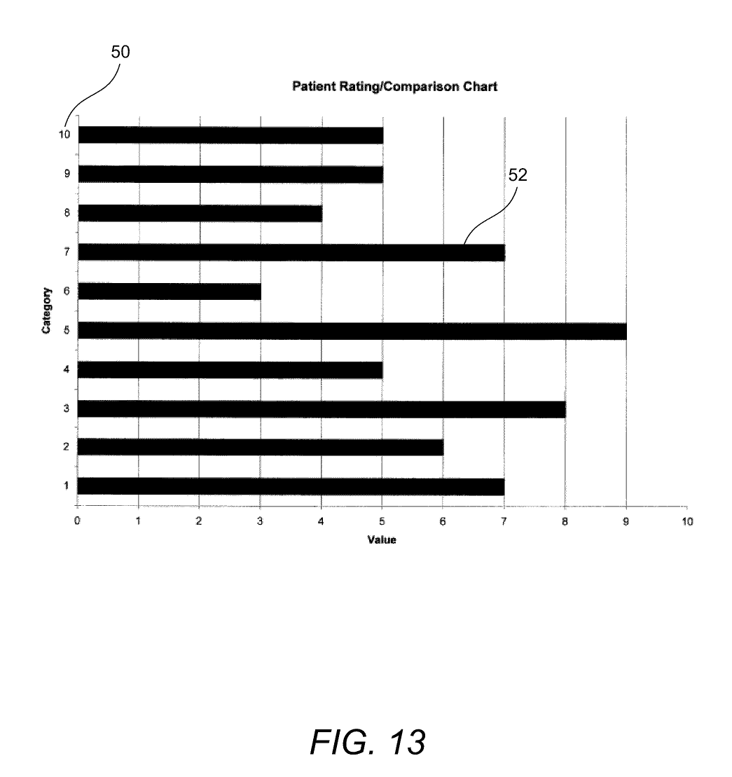

In some instances, graphical comparisons may be made between patients, as is illustrated by FIG. 13. The categories 50 of FIG. 13 may represent individual patients, and may permit rapid comparison between groups. The above-described graphical comparisons between patients and groups is meant to be merely illustrative of the various ways in which the graphical representations of the present invention may provide improved information to users, including medical professionals and laypersons.

For example, a medical professional may begin to recognize and associate certain graphical patterns with certain diagnoses. As an example, a medical professional may recognize that a certain pattern or set of graphical scores 52 in a certain score range is associated with arthritic damage. Upon later encountering a similar pattern or set of graphical scores 52, the medical professional may suspect arthritis. Furthermore, the medical professional might notice a similar pattern emerging for a certain patient, but with scores still more toward healthful than would indicate arthritic damage. The medical professional might suspect early-stage arthritis and might be able to preventatively treat the condition and/or do further testing to confirm the tentative diagnosis. In this way, embodiments of the invention might assist with diagnosis, even in earlier stages than might otherwise be caught, and with treatment.

In some embodiments it may be possible to include software-based or other semi-automatic or automatic recognition of certain graphical patterns to provide tentative or potential diagnosis information to a user. In embodiments where computer programs are utilized, the computer programs may include diagnosis information based on patterns discovered over tens, hundreds, or thousands of patients, along with the associated diagnoses. This information may be displayed with the graphical representations and/or separately.

The above descriptions of possible uses and applications of the graphical patient medical information are considered illustrative only. Additional uses and applications may be learned by the practice of the embodiments of the invention. Additionally, the illustrated graphical representations are intended to be representational only.

For example, while the illustrated graphical representations include bar charts, thereby providing linear graphical scores 52, the graphical scores 52 may be represented in any number of ways. For example, the graphical scores 52 may be represented as colors on a continuum of color. As one example, a red-green or other bi-color graphical continuum may be utilized, with one of the colors (e.g., red or green) representing a more healthful graphical score 52. The graphical scores 52 in such an embodiment may be interpreted by determining how much of one color a graphical score 52 is, or if the graphical score 52 is more in-between (e.g., brown, in the red-green scheme). It will be appreciated that such a representation of graphical scores 52 may permit more medical information to be displayed on a single graphical display, as the graphical scores 52 in such embodiments do not rely on physical size to convey the graphical scores 52.

Other non-limiting alternatives for the graphical scores 52 include shapes (such as square, triangle, circle, hexagon, etc.) for different graphical scores 52, varying shadings for different graphical scores 52, etc. As another example, black or red partially- or wholly-filled bubbles, such as are used by Consumer Reports Magazine might be used in some embodiments. An amount that a pie-chart type graph is filled might also be used to represent a graphical score 52. In sum, any graphical mechanism or method may be utilized to convey patient medical information by way of a graphical score 52. Some such systems and methods may permit more information to be displayed at a single time, while other methods and systems may be clearer when utilizing certain display media or devices, and one of skill in the art may determine a desired graphical system/method to suit a particular use.

In addition to graphical representations that include bar charts, the described systems and methods can include any other suitable graphical representation that can display graphical scores for one or more categories/subcategories of information. Indeed, in some embodiments, the graphical representation of patient medical information is provided through the use of an image depicting a physical representation of a patient or of one or more of the patient's body parts. By way of example, the representation may include a picture of the patient; a rendering of a generic human body; a depiction of a physiological system, a body part, etc.; or any other suitable depiction of a patient or portion thereof.

In such embodiments, the graphical representation can display rating information (e.g., color codes, numerical codes, etc.) for one or more categories of the patient's medical information. In one example, the graphical representation shows an outline of a human body that graphically represents several categories of the patient's health, including the patient's: neurologic/psychiatric health (as indicated by rating information in the head region), cardiovascular health (as indicated by rating information associated with a depiction of heart), skin and breasts (as indicated by rating information associated with the outline of the depiction of the body), etc. In this regard, the rating information for each category of the patient's medical information can be graphically displayed for the highest score of the subcategories in that category, the lowest score of the corresponding subcategories, an average score of the subcategories, an average of several average scores, or any other information associated with that category or any subcategory in that category. Accordingly, at the macro level, a user, such as a medical professional, can easily look at the graphical representation to determine the patient's overall status (e.g., to determine problems, healthy areas, etc.).

Where the graphical representation comprises a depiction of a patient or a portion thereof, the user can drill down through the various subcategories of the patient's medical information in any suitable manner. For instance, if the user then desires to obtain more information about a particular category of the patient's medical information, the user can select that category (e.g., by selecting a portion of the depiction of the patient) and drill down to one or more subcategories to obtain more information. Thus, if the graphical representation, at the macro level, displays rating information that indicates a significant malady in the patient's gastrointestinal tract, the user can drill down to determine the specific type, location, treatments, and/or other information related to the malady.

In other embodiments of the graphical representation, the graphical representation comprises one or more tree structures that associate rating information (e.g., color coding, or numerical coding) with one or more categories or subcategories of a patient's health information. As a result, a user can look at such embodiments and easily locate problem areas (e.g., systems) of the patient.

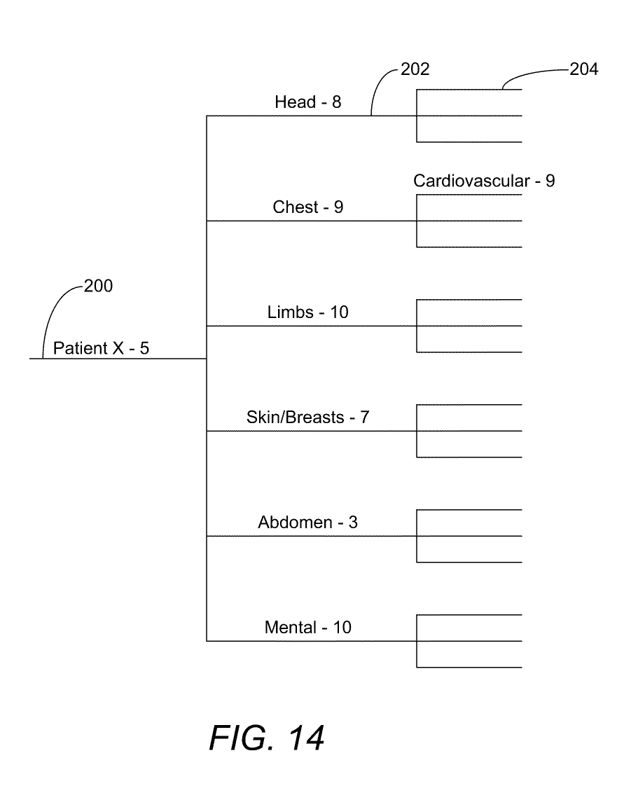

Graphical representations comprising one or more tree structures can be organized in any suitable manner that allows a user to succinctly observe rating information for one or more areas of the patient. In one example, FIG. 14 shows that the tree's trunk 200 identifies the patient and primary branches 202 from the trunk each identify a different system of the patient's body (e.g., Allergic/Immunological/Lymphatic/Endocrine, Neurologic/Psychiatric, Musculoskeletal, Genitourinary, Gastrointestinal, Respiratory, Cardiovascular, Head/Eyes/Ears/Nose/Mouth/Throat, and Skin/Breast). While FIG. 14 shows that the trunk 100 includes General/Constitutional rating information 204 (e.g., a color code, numerical score, etc.) for the patient, each primary branch 202 can include rating information based on the highest score of any corresponding sub-branches, the lowest score of any corresponding sub-branches, an average score of any corresponding sub-branches, an average of several average scores, or any other information associated with that system or any subcategory of that system.

In some embodiments in which the graphical representation comprises a tree structure, the user can drill down into specific areas (e.g., portions, systems, etc.) of the patient's health by selecting a specific secondary branch 202 (e.g., system, such as the cardiovascular system). From there, the user can continue to select one or more tertiary 204, quaternary (not shown), and/or other subset of branches to obtain additional information down to the most-detailed level.

In still other embodiments of the graphical representation of patient medical information, a computer displays one or more progress forms (e.g., medical progress forms) for a patient. In this regard, the medical progress form can comprise any suitable level of information. For instance, at the most basic level, the form provides an overall rating for the patient's health (e.g., an average rating of several key health indicators). In other instances, the form comprises rating information based on the highest score, the lowest score, an average score, an average of several average scores, or any other information associated with one or more categories/subcategories (e.g., systems) of the patient's health. In such instances, the user can drill through forms of varying detail to review categories and subcategories of the patient's health down all the way to the most-detailed level.

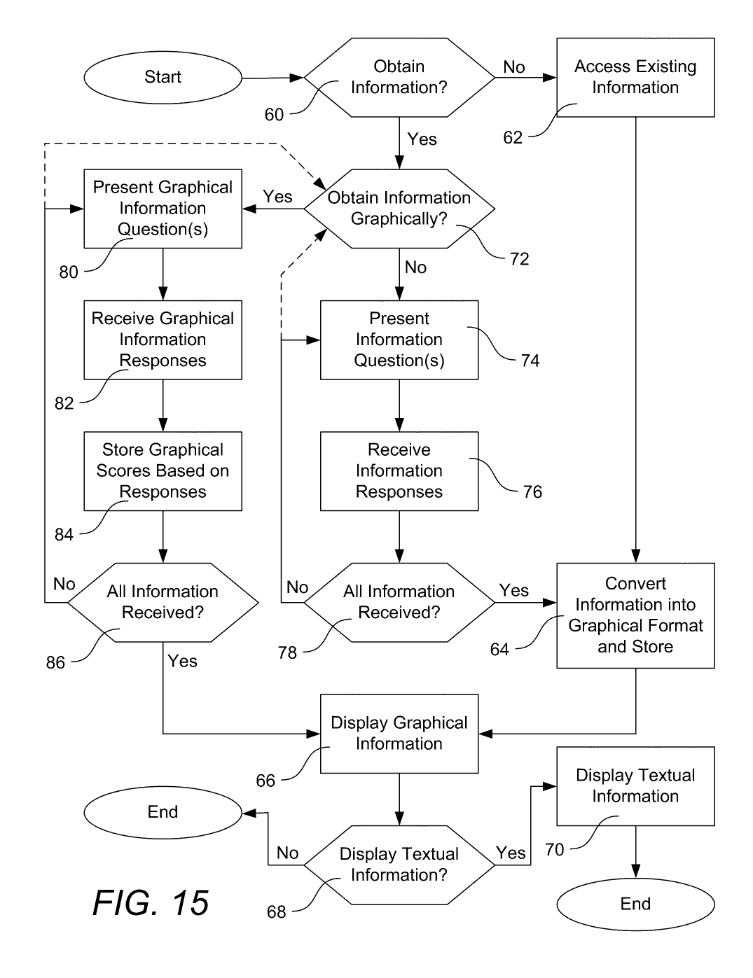

To display the graphical representations of patient medical information, the medical information may be obtained, generated, and/or converted into a graphical format. FIG. 15 therefore illustrates various illustrative methods for obtaining, generating, and/or converting medical information into a graphical format (i.e., into the graphical scores 52). FIG. 15 is a flowchart showing processes that may occur with some embodiments of the invention. Execution begins at decision block 60, where a determination is made whether to obtain patient medical information. It may be that medical information has already been obtained. For example, previously-existing information may be utilized.

If no information need be obtained at the present time, execution proceeds to accessing existing information at step 62. Once the information has been accessed, the information may be converted into a graphical format and stored in the graphical format at step 64, then displayed (either immediately or at a later time) at step 66. As set forth previously, it may be desirable to display textual-based medical information, or information in some other previously-available format, and so execution may proceed to decision block 68, where it is determined whether to display such information. This determination may be made by user input, for example. If such information is not to be displayed, execution may end (or return to some earlier point in the process), while if such information is to be displayed, it is displayed at step 70. After the textual information or other information in a preexisting format has been displayed, execution may terminate or return to some earlier point in the process.

The foregoing represents processes that may occur when utilizing preexisting information either entirely or in part. If, however, it is determined at decision block 60 that medical information is to be obtained, execution proceeds to decision block 72. At decision block 72, a determination is made whether to obtain information graphically or otherwise.

If it is determined not to obtain information graphically, execution proceeds to step 74, where one or more questions may be presented to draw out the medical information. For example, such questions may be presented by a medical professional during a patient interview, may be presented to a medical professional after observing a patient, may be presented in the form of a medical questionnaire to the patient during a patient intake procedure or otherwise, or may be otherwise presented directly to a patient, such as online. The questions presented need not all be in the form of questions, per se, but may be in any format designed to obtain medical information, and thus any method, system, or mechanism intended to draw out medical information may be utilized at step 74. Additionally, in some embodiments, the questions are structured in such a manner that the user entering the information is forced to drill down or up through information and to provide information from a general level to a most-detailed level, or vice versa.

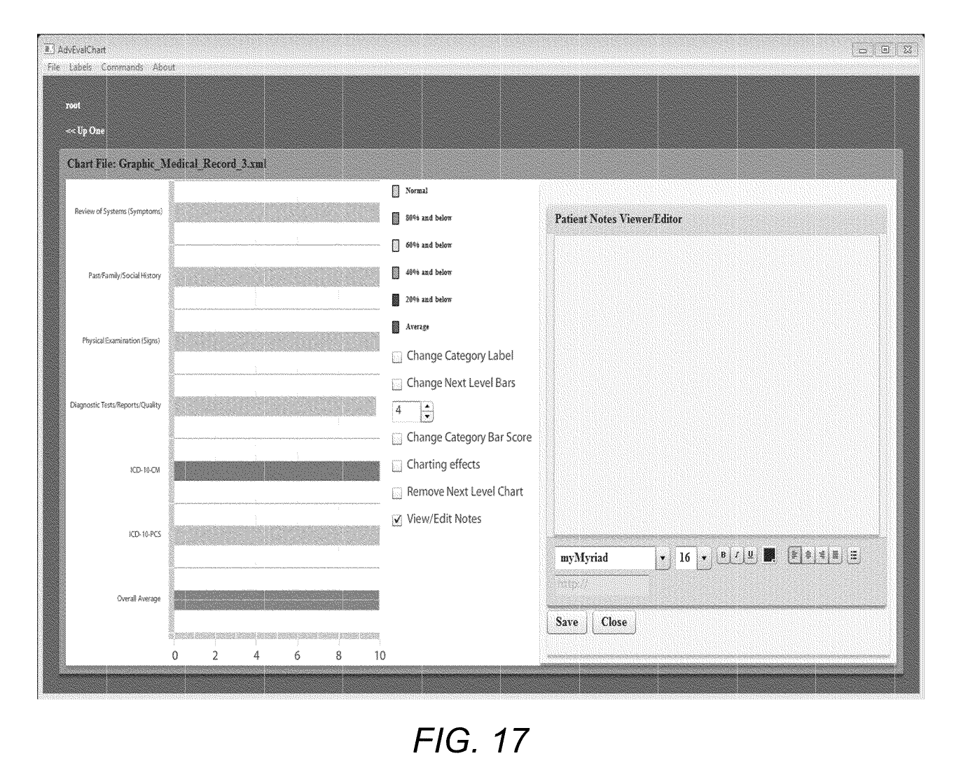

Execution may then proceed to step 76 where the medical information is received. While the medical information can be entered in any suitable manner, including by responding to questions, inputting specific medical information, etc., in some embodiments, information can be received through the use of one or more dialog or textual boxes (see e.g., FIG. 17) that allow the user to include notes or other information in the patient's medical records. While these dialog and textual boxes can be made available at any location in the patient's medical history, in some embodiments, these boxes are only available at the most-detailed levels/subcategories of the patient's medical information. In such a manner, the systems and methods can keep the less-detailed levels of the patient's medical unencumbered with the user's notes.

Execution then proceeds to decision block 78, where a determination is made as to whether all medical information has been received. If not, execution may return to step 74 where additional information question(s) may be presented, or may return to decision block 72 to determine whether any additional information should be obtained graphically or not. When all non-graphical medical information has been received, execution then proceeds to step 64 for any desired conversion of the non-graphical medical information into a graphical format, whereupon the process may continue as outlined above. Although the process has been illustrated as obtaining all information prior to conversion into a graphical format, it should be understood that conversion may occur in steps while the information is obtained, or may occur simultaneously with receipt.

While information may be obtained in non-graphical ways similar to current methods and then converted into a graphical format, the information may also be obtained graphically. Thus, if it is determined at decision block 72 to obtain information graphically, execution may proceed to step 80, where questions designed to obtain information graphically are presented. As set forth above, the graphical information questions need not necessarily be questions per se, but may include any format designed to obtain medical information. Additionally, the graphical information questions may be presented by medical professionals to patients, may be presented to medical professionals after observing a patient, may be obtained as part of test results, may be presented directly to a patient, such as part of a medical intake process or online, or may be presented and/or obtained in any other fashion. Furthermore, the graphical information questions may also require the user to provide information that corresponds to more than one category and/or subcategory of information.

The graphical information questions are designed to receive responses either in a graphical format or in a format easily and automatically converted to a graphical format. A format easily converted into a graphical format includes formats such as letter and number grades/scores within a known range or scale. Graphical responses may be received by any graphical selection method, system, or format, including graphical sliders, receipt of a graphical click or other selection on a graphically-displayed range by way of a mouse or other input device, selection of a radio button or option button, receipt of a color or intensity selection, or receipt of any other graphical signal or cue or representation thereof. However the graphical information is received, it is stored at step 84, and then a determination is made at decision block 86 whether all information has been received. If not all information has been received, execution returns to step 80 for more presentation of graphical information questions, or to decision block 72 for a determination whether the additional information is to be obtained graphically or otherwise. Once all information has been obtained, execution may proceed to step 66 for displaying of the information. As will be understood, no conversion of the graphically-received information to a graphical format need occur.

It should also be understood that receipt of graphical information and receipt of information otherwise are not exclusive of each other, and information may be received both graphically and otherwise together, whether serially or simultaneously, and may be stored both graphically and/or otherwise, together or separately. It should also be understood that information may be received, converted, obtained, etc. into a graphical format by any other method or process.

In some embodiments, a medical information graphical representation (e.g., a bar graph, tree structure, physical representation, etc.) that provides a review of systems of an individual's body (e.g., FIGS. 4-6) can be drilled up to a level that is even broader than the particular systems of the individual's body. Examples of a broader graphical view of the individual includes information relating to the individual's medical status, dietary status, financial status, education, genetic information, family traits, genetic information, family conditions, other background information, and/or other data or information that relates to the individual. Thus, the graphical representation can be drilled up to levels that provide broader categorical information relating to the individual, wherein each level drilled up is increasingly broader. Similarly, each graphical representation can allow for drilling down or into subcategories to provide more information relating to the particular subcategory, wherein each level drilled down is increasingly more focused, narrow or specific.

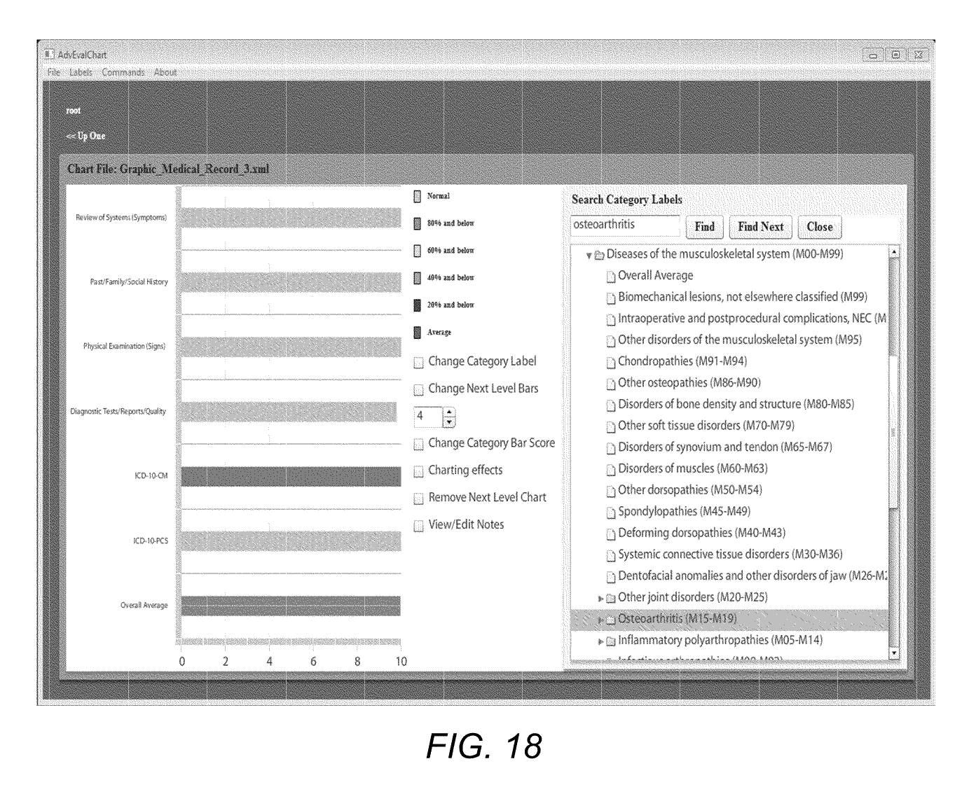

In addition to the aforementioned features, the described systems and methods can include any other suitable feature or characteristic that allows them to function as intended. In one example, the described systems and methods include a search feature that allows a user, such as a physician, to search a patient's medical information based on one or more criteria (e.g., category labels, search terms, score levels, etc.) (see FIG. 18). Indeed, in some embodiments, the search feature allows the user to search the patient's medical information for scores or rating information that hits a minimum, maximum, or desired threshold. In this manner, the user can quickly determine the various aspects of a patient's health that have problems or that are doing well.

In other embodiments, the search feature allows the user to locate a specific word or term in the patient's medical information. Indeed, in some instances, the search feature is configured to open a tree structure, a medical progress form, a representation of the patient, or another graphical representation to indicate where the search criteria is found in the patient's medical information. Once the user finds the searched criteria (e.g., rating information, search term, etc.), the user can then drill down and/or up through the patient's medical information as desired.

In another example of a suitable feature, in some embodiments, all or a portion of a patient's medical information (e.g., a medical chart) is made available to the patient. In such embodiments, the patient's chart can be made available to the patient in any suitable location (e.g., at home, in a care facility, etc.) and in any suitable manner (e.g., via the Internet, a local area network, paper, etc.). In such embodiments, the patient (or another user) can update some or all of the patient's medical information in such a manner that a user, such as a physician, can monitor the patient's progress and/or deterioration without actually seeing the patient. In one example, where a patient has received knee replacement surgery, the patient or a caretaker (e.g., a therapist) can upload or otherwise provide information (e.g., rating information) relating to the patient's pain, knee function, knee alignment, knee flexibility, etc. Accordingly, one or more users (e.g., physicians) can remotely monitor, direct, and/or encourage the patient's progress remotely.

In still another example of a suitable feature, in some embodiments, the described systems and methods are configured to collect, compile, and otherwise use billing information for services rendered, equipment used (e.g., medical equipment), and/or other charges that are incurred by the patient. In such embodiments, the described systems and methods can be modified in any suitable way that allows them to collect and use billing information. In one example, the system provides the user with forms (e.g., reimbursement forms, prescription sheets, etc.) that are relevant to the information entered.

In another example, as the user (e.g., a physician, caretaker, etc.) enters information into the described systems, the systems can force or otherwise allow the user to provide information about the specific treatment and/or diagnosis of the patient. As this occurs, the systems can prompt the user to enter enough information so that the system can match any medical equipment, material, medicine, procedure, product, etc. to a specific code (e.g., an ICD-10 code) relating to a fee. In this regard, the described systems can generate patient billing records in near real-time or at any other suitable time. Accordingly, the described systems can provide an easy way to generate bills during the diagnosis and/or treatment process. Additionally, because some embodiments save diagnosis and ICD code information, such information can automatically become part of the patient's medical history and can be reviewed on demand.

As yet another example of a suitable feature, some embodiments of the described systems and methods include a cache that allows the user to quickly navigate to specific categories and subcategories of a patients' medical information without being required to drill up or down through each of the various levels of the patient's information. In this regard, the cache may be organized in any suitable manner, including by retaining a link to information that: was most-recently visited, is related to a key indicator of the patient's health, is related to the highest and/or lowest rating information for a particular category/subcategory, the user deems important, is related to a particular diagnosis or treatment, etc. Accordingly, while the user may need to drill down through various levels during an initial diagnosis or review, the cache can allow the user to skip such steps later on.

As another example of a suitable feature, in some embodiments, the described systems and methods for graphically conveying patient medical information display one or more graphical representations of the potential improvement, progress, and/or deterioration a patient may see (also called potential status), based upon one or more specific treatments, procedures, weight loss techniques, medications, counseling, and/or other actions or inactions. In this regard, the systems can display any suitable representation that illustrates potential improvement, progress, deterioration, etc. By way of example, the graphical representation can include a line graph including a line that indicates the patient's potential improvement (e.g., lung capacity after stopping smoking), an illustration showing how the patient's body may improve (e.g., a rendering of the patient as the patient loses weight), a depiction of how a joint's range of motion may improve, or any other graphical representation showing the patient's potential status. In this manner, the described systems can help the patient see potential improvement and can otherwise motivate the patient to improve one or more aspects of his or her health.

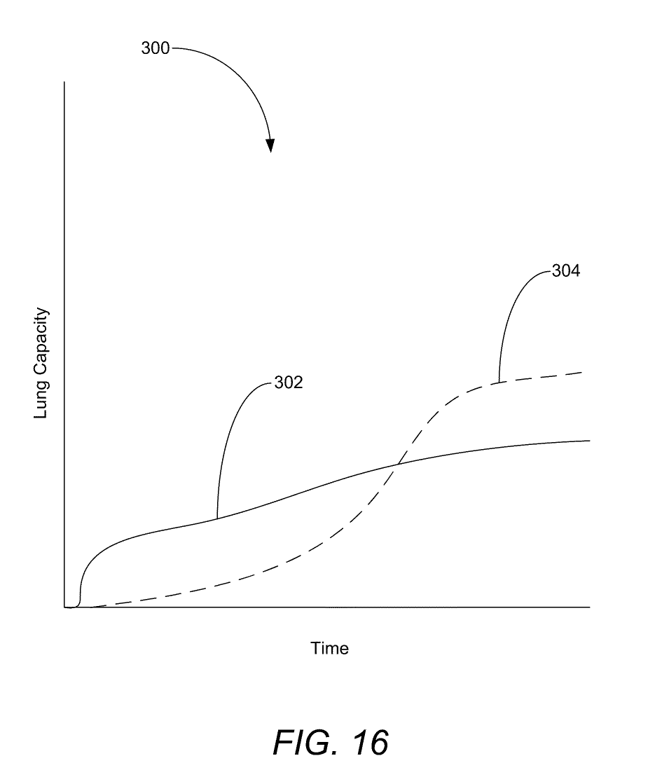

In some embodiments in which the described systems and methods display one or more graphical representations showing the patient's potential status (e.g., improvement, progress, deterioration, etc.), the systems and methods also illustrate, compare, and/or contrast the patient's actual status. In such embodiments, the systems and methods may illustrate, compare, and/or contrast the patient's actual status with the patient's potential status in any suitable manner. For instance, the systems and methods can include a line graph, bar graph, pie chart, etc. that illustrates one or more aspects of the patient's potential health status and the patient's actual health status; a depiction that indicates the patient's potential range of limb movement (e.g., where one of the patient's joints has been replaced) and the patient's actual range of limb movement; and/or any other suitable depiction showing the patient's actual status compared to the patient's potential status. By way of illustration, FIG. 16 shows a line graph 300 depicting a first line 302, representing the patient's actual lung capacity after smoking, compared with a second line 304, representing the proposed lung capacity.

As still another example of a suitable feature, some embodiments of the described systems and methods allow a user to upload and/or update patient medical information in near real-time. Accordingly, such embodiments can provide the user with a near real-time analysis of the patient's information. Additionally, in some embodiments, as the user enters information, the system asks the user additional questions to help diagnose the patient, determine the best method for treatment, or otherwise help improve the patient's medical experience. In other embodiments, as information is entered into the system, the system provides the user (e.g., physician) with relevant information, which may include, without limitation, a suggestion to conduct a certain test or procedure, a suggestion to use a certain medicine or treatment, a warning of potential drug interactions, a warning of possible complications, a list of equipment that can be used or ordered for a particular treatment, a list of medical professionals who specialize in a relevant treatment, and other forms of suitable information.

Because (as discussed above) some embodiments of the described systems and methods are implemented with a network (e.g., via cloud computing, a local area network, a wide area network, etc.), a patient's medical information may be available to more than one user at a time and may be accessed from many different physical locations. Accordingly, the described systems and methods can allow for collaborative efforts between users (e.g., physicians) and can easily allow a wide range of users to provide and/or access a cumulative perspective of the patient's health.

Accordingly, embodiments of the present invention relate to graphically representing aspects of an individual for rapidly conveying information about that individual, wherein the information can be anywhere from a macro level of the individual to a micro level of the individual, and wherein the various levels can be drilled up to convey broader information and drilled down to convey more focused, narrow, or specific information.

Thus, as discussed herein, embodiments of the present invention relate to systems and methods for graphically displaying and navigating through information, and more particularly to graphical methods and systems for rapidly conveying information, such as medical information.

While the systems and methods of the present invention have proven to be particularly useful in the area of medical care, those skilled in the art can appreciate that the described systems and methods can be used in a variety of different applications, including in the area of providing dietary decisions, fitness evaluation, weight loss counseling, exercise coaching, automotive repair, educational counseling, inventory/sales reporting, and other types of care, diagnosis, treatment, and/or analysis to an individual, group, or entity.

In one example, the described systems are used to graphically convey maintenance information about a vehicle. As used herein, the term maintenance information may be used broadly to refer to error codes, damaged parts, vehicle make, vehicle model, year, miles, and any other information relevant to the repair or maintenance of a vehicle. In this example, the system can provide one or more graphical representations (e.g., bar graphs, pie charts, tree structures, progress forms, etc. of various categories and subcategories of the maintenance information) in a manner similar to that described above to help diagnose problems, fix the vehicle, charge for parts and services, and to otherwise help improve the maintenance/repair process.

In another example, the described systems are used to graphically convey educational information relating to one or more students' education. In this regard, the term educational information may be used broadly herein to refer to one or more students' grades, levels of education, transcripts, majors, and any other information relevant to the students' education. In this example, the system can provide one or more graphical representations (e.g., bar graphs, pie charts, tree structures, progress forms, etc. of various categories and subcategories of the student's educational information) in a manner similar to that described above, to help diagnose problems in the student's education, direct the student towards graduation, charge for classes, and to otherwise help improve the student's educational process.

In still another non-limiting example, the described systems are used to graphically convey inventory/sales information. In this regard, the term inventory/sales information may be used broadly herein to refer to one or more inventory levels, prices, sale reports, and any other information relevant to inventory and sales. In this example, the system can provide one or more graphical representations (e.g., bar graphs, pie charts, tree structures, progress forms, etc. of various categories and subcategories of the maintenance information) in a manner similar to that described above, to help diagnose shortages or overages in inventory, ways to improve sales, reasons for deficiencies in sales, and to otherwise help improve the process of selling or controlling inventory.

The present invention may be embodied in other specific forms without departing from its spirit or essential characteristics. The described embodiments and examples are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed and desired to be secured by Letters Patent is:

1. A system for graphically conveying information, the system comprising:
a category of information;
multiple subcategories of information in the category;
a graphical subcategory score associated with each of the subcategories; and
a display mechanism for communicating, in a graphically succinct manner, a graphical category score for the category, wherein the graphical category score is selected from:
(i) an average of the graphical subcategory scores,
(ii) a highest graphical subcategory score, and
(iii) a lowest graphical subcategory score.

2. The system of claim 1, wherein the graphical category score and the category are displayed on the display mechanism.

3. The system of claim 1, wherein the information is selected from:
(i) medical information,
(ii) educational information,
(iii) maintenance information, and
(iv) inventory/sales information.

4. The system of claim 1, wherein the information comprises medical information.

5. The system of claim 4, wherein the system automatically records billing information as medical information is entered into the system.

6. The system of claim 1, wherein the category and subcategories are displayed in a tree structure.

7. The system of claim 1, wherein the category and subcategories are displayed through the use of a depiction of an object selected from:
(i) a patient, and
(ii) a part of the patient.

8. The system of claim 1, wherein each of the subcategories further comprises multiple sub-subcategories of information, wherein each of the sub-subcategories comprises a graphical sub-subcategory score, and wherein the graphical subcategory score for each subcategory is selected from:
(i) an average of the graphical sub-subcategory scores,
(ii) a highest graphical sub-subcategory score, and
(iii) a lowest graphical sub-subcategory score.

9. The system of claim 1, further comprising means for selecting at least one of the subcategories.

10. The system of claim 1, wherein the graphical category score and graphical subcategory score are each represented by at least one of:
(i) a color;
(ii) a shape;
(iii) a shading;
(iv) an intensity;
(v) a design;
(vi) a graph; and
(vii) a pattern.

11. A computer program product for implementing within a computer system a method for graphically accessing and rendering patient medical information, the computer program product comprising:
a non-transitory, computer-readable medium for providing computer program code means utilized to implement the method, wherein the computer program code means is comprised of executable code for implementing steps for:
rendering a category of medical information, wherein the category of information is associated with a plurality of subcategories of medical information, and wherein each subcategory is associated with a graphical subcategory score; and
rendering in a graphically succinct manner a graphical category score that is associated with the category, wherein the graphical category score is selected from:
(i) an average of the graphical subcategory scores,
(ii) a highest graphical subcategory score, and
(iii) a lowest graphical subcategory score.

12. The computer program product as recited in claim 11, wherein the computer program code means further comprises executable code for implementing a step for associating at least some of the subcategories of medical information into a layered hierarchical relationship.

13. The computer program product as recited in claim 12, wherein the layered hierarchical relationship comprises layers of average scores.

14. The computer program product as recited in claim 12, wherein the computer program code means further comprises executable code for implementing a step for allowing a user to drill from one layer to another layer in order to access the medical information.

15. The computer program product as recited in claim 14, wherein the computer program code means further comprises executable code for implementing a step for providing a bread crumb trail indicating layers that have been accessed by the user.

16. The computer program product as recited in claim 11, wherein the category of medical information is rendered in connection with a graphical representation selected from:
(i) a depiction of a patient,
(ii) a depiction of a portion of a patient,
(iii) a progress form; and
(iv) a tree structure.

17. A graphical communication method for succinctly and effectively communicating patient medical information, the method comprising:
identifying a first category of medical information;
identifying multiple subcategories of medical information belonging to the first category of medical information; and
using a display to render a graphical category score for the first category of medical information,
identifying a graphical subcategory score for each of the subcategories,
wherein the graphical category score is selected from:
(i) an average of the graphical subcategory scores,
(ii) a highest graphical subcategory score, and
(iii) a lowest graphical subcategory score.

18. The method of claim 17, further comprising identifying billing information as additional medical information is identified.

19. The method of claim 17, wherein the graphical category score comprises a color.

20. The method of claim 17, further comprising drilling down from the category to one of the subcategories to view additional medical information.
